(19) United States
(12) Patent Application Publication
(10) Pub. No.: US 2007/0217117 A1
(43) Pub. Date: Sep. 20, 2007

(54) Electrostatic chuck and producing method thereof

(75) Inventors: Mitsuru Ohta, Inazawa-Shi (JP); Takeru Torigoe, Handa-Shi (JP); Yasuyoshi Imai, Santa Clara, CA (US)

Correspondence Address: BURR & BROWN, PO BOX 7068, SYRACUSE, NY, 13261-7068, US

(73) Assignee: NGK Insulators, Ltd., Nagoya-Shi (JP)

(21) Appl. No.: 11/400,770

(22) Filed: Apr. 7, 2006

(30) Foreign Application Priority Data
Mar. 3, 2006 (JP) 2006-057811

(51) Int. Cl. H01T 23/00

(52) U.S. Cl. 361/234

(57) ABSTRACT

An electrostatic chuck using the Johnson-Rahbek force, comprising: a dielectric material layer including a ceramics layer and a resin layer formed on the ceramics layer; and an electrode for generating an electrostatic adsorption power.

### CROSS-REFERENCE TO RELATED APPLICATION

This application is based upon and claims the benefit from the prior Japanese Application No. 2006-057811, filed on Mar. 3, 2006; the entire contents of which are incorporated herein by reference.

### BACKGROUND OF THE INVENTION

1. Field of the Invention

The present invention relates to an electrostatic chuck and a producing method thereof.

2. Description of the Related Art

Conventional processes for manufacturing semiconductors and liquid crystal have used an electrostatic chuck that adsorbs and retains a semiconductor substrate and a glass substrate. An electrostatic chuck is classified to the one that uses the Coulomb force to adsorb a substrate and the one that uses the Johnson-Rahbek force to adsorb a substrate. The Coulomb force is an electrostatic adsorption power generated between a substrate placed on a surface of a dielectric material layer of an electrostatic chuck and an electrode of the electrostatic chuck. The Johnson-Rahbek force is an electrostatic adsorption power generated between a substrate placed on a surface of a dielectric material layer of an electrostatic chuck and the surface of the dielectric material layer. When an electrostatic chuck using the Johnson-Rahbek force is used, minute leak current must be flowed in a substrate.

A dielectric material layer of an electrostatic chuck is made of material such as ceramics or polyimide resin (e.g., see Japanese Patent Unexamined Publication No. 8-148549).

This dielectric material layer made of polyimide resin is inferior to a dielectric material layer made of ceramics in the corrosion resistance and heat resistance, which deteriorates an electrostatic chuck including the dielectric material layer made of polyimide resin. Furthermore, in the case of the electrostatic chuck using the Coulomb force, a variation in the thickness of the dielectric material layer directly leads to a variation of the adsorption power. This has caused a necessity to control the thickness of a dielectric material layer of the electrostatic chuck using the Coulomb force in a stricter manner than in the case where an electrostatic chuck using the Johnson-Rahbek force is used.

On the other hand, when an electrostatic chuck having a dielectric material layer made of ceramics and using the Johnson-Rahbek force is used, the electrostatic chuck can have an improved durability owing to the ceramics-made dielectric material layer having superior corrosion resistance and heat resistance. The electrostatic chuck having the ceramics-made dielectric material also does not require the strict thickness control of the dielectric material layer as required by the electrostatic chuck using the Coulomb force.

However, the electrostatic chuck having the ceramics-made dielectric material layer and using the Johnson-Rahbek force has been involved with a risk where excessive and more than required leak current may be generated. This may have caused an influence on a substrate adsorbed by the electrostatic chuck, which may cause an influence on a device finally obtained.

Furthermore, the Johnson-Rahbek force is an electrostatic adsorption power generated between a surface of a dielectric material layer and a substrate placed on the dielectric material layer. Thus, the Johnson-Rahbek force has an adsorption characteristic that significantly depends on the condition of the surface of the ceramics-made dielectric material layer. This has caused a case where, when the condition of the surface of the dielectric material layer is changed due to the use for a long period of time, the adsorption characteristic of the electrostatic chuck is also changed, preventing an original adsorption characteristic from being maintained. Furthermore, electric charge tends to remain in the ceramics-made dielectric material layer even when voltage application to the electrode is stopped, deteriorating the detachment smoothness level of a substrate from the electrostatic chuck. Furthermore, when the ceramics-made dielectric material layer is in friction with the substrate, the ceramics-made dielectric material layer tends to scratch the back face of the substrate, which may cause particles.

In view of the above, it is an objective of the present invention, in an electrostatic chuck using the Johnson-Rahbek force, to suppress excessive leak current from being generated; to maintain the adsorption characteristic for a long time; to improve the detachment smoothness level of a substrate from the electrostatic chuck; and to reduce the generation of particles.

### SUMMARY OF THE INVENTION

The electrostatic chuck of the present invention is an electrostatic chuck using the Johnson-Rahbek force, characterized in comprising: a dielectric material layer including a ceramics layer and a resin layer formed on the ceramics layer; and an electrode for generating an electrostatic adsorption power.

The electrostatic chuck as described above can use the resin layer on the ceramics layer to suppress the generation of excessive leak current. The dielectric material layer has a superior corrosion resistance owing to the ceramics layer on the inner layer side and the condition of the surface does not change owing to the resin layer on the surface layer side even when the electrostatic chuck is used for a long time. Thus, the electrostatic chuck can maintain the adsorption characteristic for a long period of time.

Furthermore, in the electrostatic chuck of the present invention, polarization is caused in the resin layer, contributing to the generation of an electrostatic adsorption power. This prevents electric charge from remaining in the ceramics layer after voltage application to the electrodes is stopped. As a result, the electrostatic chuck using the Johnson-Rahbek force can have an improved detachment smoothness level of the substrate therefrom.

It is preferable that the ceramics layer has a volume resistivity value at room temperature of 1×10⁸ to 1×10¹³ Ω·cm; and the dielectric material layer has a volume resistivity value at room temperature of 1×10¹⁴ Ω·cm or more. By adjusting the volume resistivity value of the ceramics layer at room temperature as described above, the volume resistivity value of the dielectric material layer at room temperature after the formation of the resin layer can be 1×10¹⁴ Ω·cm or more. This can improve the adsorption power and the detachment smoothness level.

The dielectric material layer preferably has projections for supporting a substrate. This can further improve the detachment smoothness level of the substrate. The structure of the dielectric material layer in which the resin layer softer than the ceramics layer is formed on the ceramics layer can also prevent particles or scratch caused when the projections of the dielectric material layer are in friction with the substrate.

The resin layer preferably has a thickness of 1 to 30 μm. The thinner the resin layer is, the larger the adsorption power is. However, the thickness of the resin layer smaller than 1 μm causes poor insulation of the resin layer itself while the thickness of the resin layer larger than 30 μm reduces the adsorption power, which causes an in-plane variation of the thickness of the resin layer to increase an in-plane variation of the adsorption power. This resin layer can further suppress the generation of excessive leak current to improve the voltage resistance of the electrostatic chuck. The existence of the resin layer having such a thin thickness can also provide a uniform in-plane distribution of the adsorption power.

The resin layer is preferably formed by fluorocarbon resin. The resin layer covering the entire surface of the electrostatic chuck improves an effect for reducing particles. The ceramics layer preferably includes aluminum nitride or aluminum oxide. This can improve the durability and voltage resistance of the electrostatic chuck.

A difference in a thermal expansion coefficient between the ceramics layer and the resin layer is preferably 1×10⁻⁶ to 5×10⁻⁴/K. This can improve the contact between the ceramics layer and the resin layer to further suppress the generation of excessive leak current. Alternatively, the ceramics layer and the resin layer may have therebetween a primer layer. This can also improve the contact between the ceramics layer and the resin layer, thus further suppressing the generation of excessive leak current.

A producing method of the electrostatic chuck of the present invention is a producing method of the electrostatic chuck using the Johnson-Rahbek force, characterized in comprising: a step for forming a dielectric material layer including a ceramics layer and a resin layer formed on the ceramics layer; and a step for forming an electrode for generating an electrostatic adsorption power.

According to the present invention, such an electrostatic chuck using the Johnson-Rahbek force can be provided that suppresses excessive leak current from being generated, that maintains the adsorption characteristic for a long time, that improves the detachment smoothness level of a substrate therefrom, and that reduces the generation of particles.

### BRIEF DESCRIPTION OF THE DRAWINGS

FIG. 1A is a cross-sectional view illustrating an electrostatic chuck according to an embodiment of the present invention.

FIG. 1B is a top view illustrating the electrostatic chuck according to the embodiment of the present invention.

FIG. 2A is a cross-sectional view illustrating a dielectric material layer according to the embodiment of the present invention.

FIG. 2B is a cross-sectional view illustrating a dielectric material layer according to the embodiment of the present invention.

FIG. 2C is a cross-sectional view illustrating a dielectric material layer according to the embodiment of the present invention.

FIG. 3 is a flow diagram illustrating a method for producing the electrostatic chuck according to the embodiment of the present invention.

FIG. 4 is a graph illustrating an adsorption characteristic and a detachment smoothness level of the electrostatic chuck according to the embodiment of the present invention.

### DETAILED DESCRIPTION OF THE INVENTION

Hereinafter, an electrostatic chuck according to an embodiment of the present invention is described in detail with reference to the drawings.

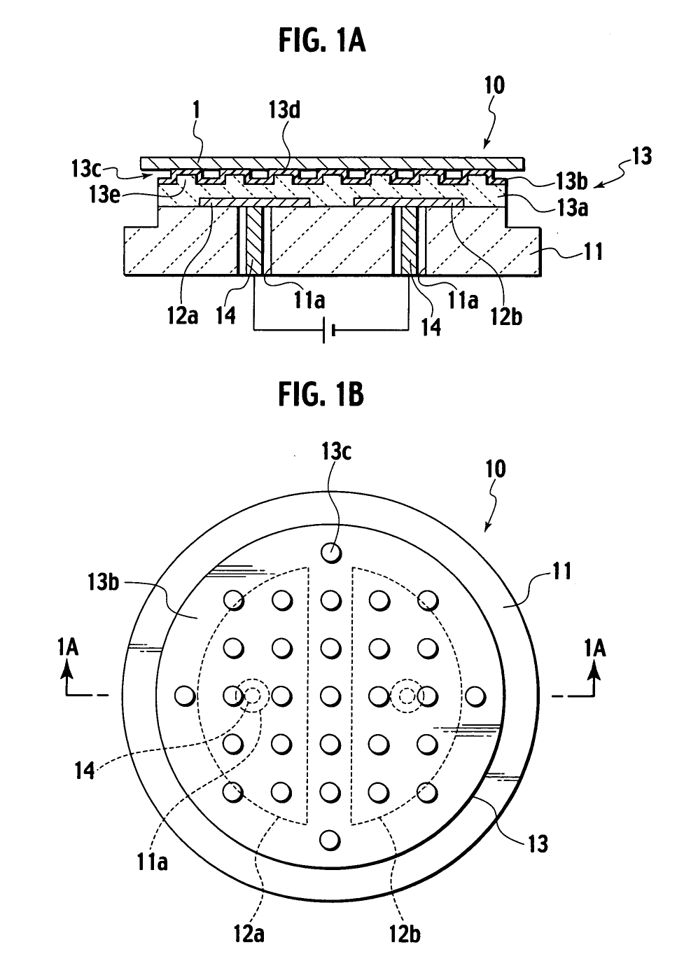

FIG. 1A is a cross-sectional view illustrating an electrostatic chuck according to an embodiment of the present invention. FIG. 1B is a top view illustrating the electrostatic chuck shown in FIG. 1A. FIG. 1A is a cross-sectional view by cutting an electrostatic chuck 10 at a line 1A-1A of FIG. 1B. As shown in FIG. 1A and FIG. 1B, the electrostatic chuck 10 includes: a base body 11; electrodes 12a and 12b provided on this base body 11; a dielectric material layer 13 provided on the base body 11 so that the electrodes 12a and 12b are buried in the dielectric material layer 13; and terminals 14 connected to the electrodes 12a and 12b. The dielectric material layer 13 includes a ceramics layer 13a and a resin layer 13b. The ceramics layer 13a has a contact with the electrodes 12a and 12b and the resin layer 13b is on the ceramics layer 13a and has a contact with the substrate 1. The electrostatic chuck 10 is an electrostatic chuck that uses the Johnson-Rahbek force.

The base body 11 supports the electrodes 12a and 12b as well as the dielectric material layer 13. The base body 11 can be formed by ceramics, metal, or composite material of metal and ceramics for example. The base body 11 is preferably made by the same material as that of the ceramics layer 13a. The base body 11 is a disk-like plate for example that has holes 11a to which the terminals 14 are inserted.

The dielectric material layer 13 is provided on the base body 11. The dielectric material layer 13 includes the ceramics layer 13a and the resin layer 13b provided on this ceramics layer 13a. The substrate 1 is placed on a surface of the resin layer 13b of the dielectric material layer 13 and this surface functions as a substrate contact face 13d having a contact with the substrate 1.

The dielectric material layer 13 preferably has projections 13c that are provided at a position opposed to the substrate 1 and that support the substrate 1. This can further improve the detachment smoothness level of the substrate 1. Furthermore, the dielectric material layer 13 shown in FIG. 1A and FIG. 1B is structured so that the resin layer 13b softer than the ceramics layer is formed over the entire surface of the ceramics layer 13a. This can prevent the generation of particles or scratches when the projections 13c of the dielectric material layer 13 are in friction with the substrate. Furthermore, the projections 13c of the dielectric material layer 13 can provide a space between the substrate 1 and the dielectric material layer 13 to which gas can be flowed. Thus, the substrate 1 can have a uniform temperature.

Each of the projections 13c preferably has a height of 1 to 60 μm. Furthermore, the projections 13c are preferably provided to have an interval of 5 to 25 mm there among. These height and interval can provide a uniform temperature distribution of the substrate 1. Each of the projections 13c more preferably has a height of 1 to 15 μm and the projections 13c are more preferably provided to have an interval of 5 to 20 mm there among.

Each of the projections 13c is not limited to one particular shape and can have a rectangular column-like shape, a circular cylinder-like shape, or a hemisphere-like shape for example. When each of the projections 13c has a rectangular column-like shape, the rectangular column preferably has a width of 0.1 to 4.5 mm. When each of the projections 13c has a circular cylinder-like shape or a hemisphere-like shape, the diameter is preferably 0.1 to 4.5 mm. This can provide a uniform temperature distribution of the substrate 1.

The dielectric material layer 13 preferably has a volume resistivity value at room temperature of 1×10¹⁴ Ω·cm or more. This can further improve the adsorption power and the detachment smoothness level. More preferably, the dielectric material layer 13 has a volume resistivity value at room temperature of 1×10¹⁵ to 1×10¹⁸ Ω·cm. Furthermore, the dielectric material layer 13 preferably has a thickness of 0.2 to 2.0 mm. This can provide a high adsorption power. More preferably, the dielectric material layer 13 has a thickness of 0.4 to 1.5 mm. When the projections 13c are formed, the thickness of the dielectric material layer 13 is represented by the largest thickness of the dielectric material layer 13 (i.e., the thickness of a part including the projections 13c).

The ceramics layer 13a of the dielectric material layer 13 preferably includes aluminum nitride or aluminum oxide. This can improve the durability and voltage resistance of the electrostatic chuck 10. For example, the ceramics layer 13a can be provided by an aluminum nitride sintered body, an aluminum oxide sintered body, or a sintered body including aluminum oxide and titanic oxide for example.

The ceramics layer 13a preferably has a volume resistivity value at room temperature of 1×10⁸ to 1×10¹³ Ω·cm. By adjusting the volume resistivity value of the ceramics layer 13a at room temperature as described above, the volume resistivity value of the entire dielectric material layer 13 at room temperature after the resin layer 13b is formed can be 1×10¹⁴ Ω·cm or more. More preferably, the ceramics layer 13a has a volume resistivity value at room temperature of 1×10⁸ to 1×10¹² Ω·cm.

The resin layer 13b of the dielectric material layer 13 can be provided by fluorocarbon resin, epoxy resin, acrylic resin, or silicone resin for example. The resin layer 13b is preferably formed by fluorocarbon resin in particular. Fluorocarbon resin includes, for example, polytetrafluoroethylene (PTFE), tetrafluoroethylene-perfluoroalkylvinylether copolymer (PFA), tetrafluoroethylene-hexafluoropropylene copolymer (FEP), or tetrafluoroethylene-ethylene copolymer (ETFE) for example. Fluorocarbon resin may also be a mixture of fluorocarbon resin with another resin such as polyamide.

The resin layer 13b preferably has a thickness of 1 to 30 μm. This can further suppress the generation of excessive leak current and can also improve the voltage resistance of the electrostatic chuck 10. Furthermore, the existence of the resin layer 13b having such a thin thickness can provide a uniform in-plane distribution of the adsorption power. More preferably, the resin layer 13b has a thickness of 5 to 15 μm. The resin layer 13b may have a film-like or sheet-like shape.

Furthermore, the variation of the thickness of the resin layer 13b is preferably 10 μm or less. In the electrostatic chuck 10, polarization in the resin layer 13b contributes to the expression of the adsorption power. Thus, the suppression of the thickness variation of the resin layer 13b can secure, even when the electrodes 12a and 12b have some variation in the thickness, a uniform in-plane adsorption power. The wording “the variation of the thickness of the resin layer 13b of 10 μm or less” means that the difference between the maximum thickness value and the minimum thickness value of the resin layer 13b is 10 μm or less.

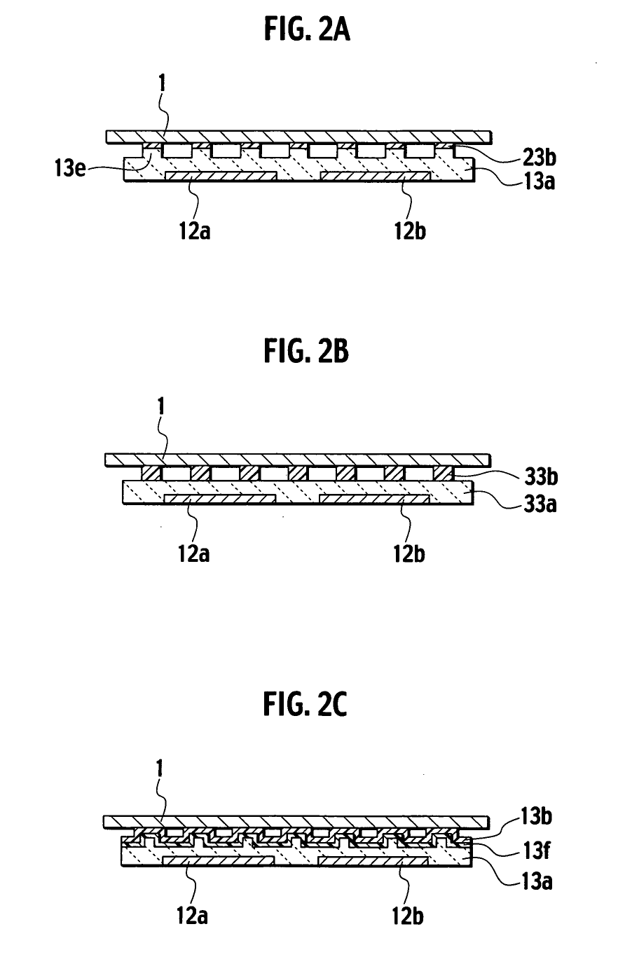

The resin layer 13b is preferably formed at least at a position at which the resin layer 13b has a contact with the substrate 1. For example, when the ceramics layer 13a itself includes projections 13e as a base of the projections 13c as shown in FIG. 1A, the resin layer 13b is preferably formed so as to cover the top faces of the projections 13e formed on the ceramics layer 13a. However, the dielectric material layer of the electrostatic chuck of the present invention is not limited to the embodiment as shown in FIG. 1A of the resin layer 13b formed so as to cover the entire top face of the ceramics layer 13a. FIG. 2A, FIG. 2B, and FIG. 2C are cross-sectional views illustrating dielectric material layers according to other embodiments of the present invention. The resin layer 23b shown in FIG. 2A shows an embodiment where the resin layer 23b is formed so as to cover only the top faces of the projections 13e formed on the ceramics layer 13a and this resin layer 23b may also be used. However, the resin layer as shown in FIG. 1A that is provided so as to cover the entire top face of the ceramics layer 13a is more preferable because the resin layer plays a role for preventing particles in the ceramics layer from escaping, thus providing a further improved effect of reducing particles.

Another structure as shown in FIG. 2 may also be used in which the ceramics layer 33a is formed that has a flat surface on which a resin layer is provided so that the ceramics layer 33a has thereon the resin layer 33b as projections for supporting the substrate 1. This structure can also provide the resin layer 33b at position at which the resin layer 33b has a contact with the substrate 1 and the dielectric material layer can have projections.

The difference between the thermal expansion coefficient of the ceramics layer 13a and that of the resin layer 13b is preferably 1×10⁻⁶ to 5×10⁴/K. This can improve the contact between the ceramics layer 13a and the resin layer 13b and can further suppress the generation of excessive leak current. More preferably, the difference of the thermal expansion coefficient is 1×10⁻⁶ to 5×10⁻⁶/K.

The electrodes 12a and 12b generate an electrostatic adsorption power. The electrodes 12a and 12b are provided between the base body 11 and the ceramics layer 13a of the dielectric material layer 13. In the electrostatic chuck 10 shown in FIG. 1A and FIG. 1B, the electrodes 12a and 12b are buried between the base body 11 and the dielectric material layer 13. In this embodiment, the electrode 12a and the electrode 12b are handled as a pair and function as bipolar type electrodes. One electrode 12a is connected to a positive electrode while the other electrode 12b is connected to a negative electrode. The planar shape of the electrodes 12a and 12b is not limited. For example, the electrodes 12a and 12b may have a semicircular shape as shown in FIG. 1B or may have a comb-like shape, a mesh-like shape, or a vortex shape. The number of electrodes is not limited to two and may be more than two or a single pole-type electrode may also be used.

The electrodes 12a and 12b can be the one printed with printing paste, a bulk, or a thin film formed by CVD (Chemical Vapor Deposition) or PVD (Physical Vapor Deposition). The electrodes 12a and 12b can be provided by material having a high melting point such as tungsten (W), niobium (Nb), molybdenum (Mo), or tungsten carbide (WC). The terminals 14 are connected to the electrodes 12a and 12b by brazing for example.

As described above, the base body 11 is made of ceramics and the dielectric material layer 13 includes the ceramics layer 13a. Thus, the base body 11, the ceramics layer 13a of the dielectric material layer 13, and the electrodes 12a and 12b are preferably structured so as to provide an integrated sintered body. This can provide a strong connection among the base body 11, the ceramics layer 13a, and the electrodes 12a and 12b, thus further suppressing the generation of excessive leak current. A particularly preferable integrated sintered body of the base body 11, the ceramics layer 13a, and the electrodes 12a and 12b is provided by the hot press method.

Furthermore, as shown in FIG. 2C, the dielectric material layer 13 may be structured so that a primer layer 13f is provided between the ceramics layer 13a and the resin layer 13b. The primer layer 13f is a layer for improving the contact between the ceramics layer 13a and the resin layer 13b. The existence of the primer layer 13f as described above can improve the contact between the ceramics layer 13a and the resin layer 13b, thereby preventing the resin layer from being peeled and allowing the resin layer to have a longer life.

The electrostatic chuck 10 may also have another structure in which a resistance heating element is buried in the base body 11 so that the substrate 1 can be heated. The resistance heating element can be provided by niobium, molybdenum, or tungsten for example. The resistance heating element can have a linear shape, a coil-like shape, a strip shape, or a mesh shape for example. The resistance heating element generates heat when being supplied with electric power.

Next, an embodiment of a method for producing the electrostatic chuck of the present invention is described.

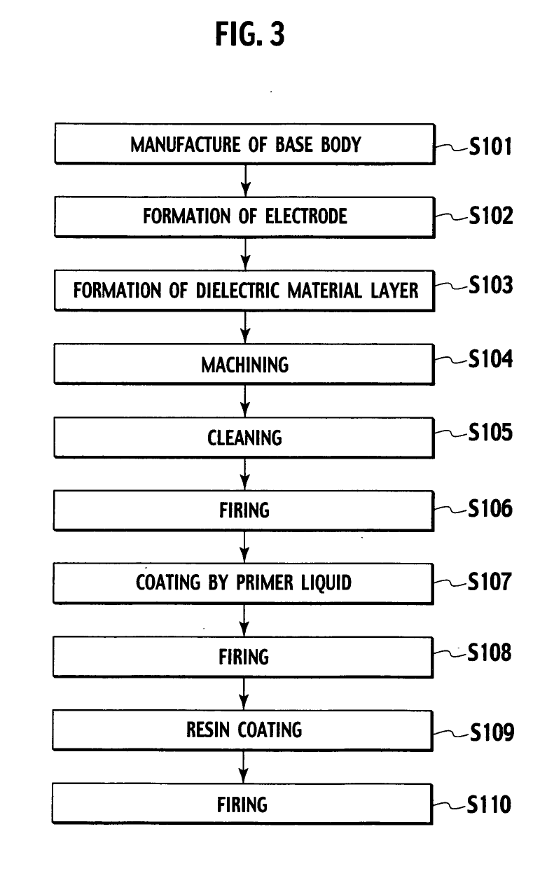

The method for producing the electrostatic chuck 10 as described above has a step for forming the dielectric material layer 13 that includes the ceramics layer 13a and the resin layer 13b provided on the ceramics layer 13a; and a step for forming an electrode for generating an electrostatic adsorption power. This producing method is described in more detail with reference to FIG. 3. The following section describes a case where an electrostatic chuck including a dielectric material layer having the primer layer 13f shown in FIG. 2C is produced. The following section also assumes that the base body 11 is manufactured as a ceramics base body such as an aluminum nitride sintered body or an aluminum oxide sintered body for example.

First, the base body 11 is manufactured (S101) The base body 11 is manufactured by firstly adding binder to ceramics raw powders, and water or dispersing agent or the like as required, and mixing them to prepare slurry. The ceramics raw powders can include aluminum nitride or aluminum oxide powders as a main component and sintering agent. The resultant slurry is granulated by the spray granulation method or the like to provide granulated powders. The resultant granulated powders are formed by a molding method such as the metallic molding method, the CIP (Cold Isostatic Pressing) method, or the slip casting method. The resultant compact is fired based on firing conditions (e.g., firing atmosphere, firing method, firing temperature, firing time) depending on the ceramics raw powders, thereby providing the ceramics base body 11.

Next, the electrodes 12a and 12b are formed on the base body 11 (S102). The electrodes 12a and 12b can be formed, for example, by printing a printing paste on the surface of the base body 11 by the screen printing method for example so as to provide a semicircular shape, a comb-like shape, a mesh-like shape, or a vortex shape. Alternatively, the electrodes 12a and 12b can also be formed by placing, on the surface of the base body 11, a bulk having a semicircular shape, a comb-like shape, a mesh-like shape, or a vortex shape. Alternatively, the electrodes 12a and 12b may also be provided by placing, on the surface of the base body 11, a thin film having a semicircular shape, a comb-like shape, a mesh-like shape, or a vortex shape by CVD or PVD.

When the electrodes 12a and 12b are provided by printing, such printing paste is preferable that is obtained from mixed powders of material having a high melting point (e.g., tungsten, niobium, molybdenum, tungsten carbide) and ceramics of the same kind as that of the ceramics layer 13a and the base body 11. This can allow the electrodes 12a and 12b to have a thermal expansion coefficient closer to those of the ceramics layer 13a and base body 11. Thus, the base body 11 and the ceramics layer 13a can be connected with and the electrodes 12a and 12b in a stronger manner.

Next, the ceramics layer 13a of the dielectric material layer 13 is formed (S103). As in the manufacture of the base body 11, granulated powders are produced by ceramics raw powders as a main component of the ceramics layer 13a. The base body 11 and the electrodes 12a and 12b formed thereon are set in a metal mold for example. Then, the resultant granulated powders are filled on the base body 11 and the electrodes 12a and 12b to provide a ceramics compact on the base body 11. Alternatively, a ceramics compact may also be provided on the base body 11 by forming the ceramics compact from the granulated powders by the metallic mold press molding method, the CIP (Cold Isostatic Pressing) method, the slip casting method or the like, and pressin the compact placed on the base body 11.

Then, the base body 11, the electrodes 12a and 12b, and the ceramics compact are integrally fired by the hot press method for providing an integrated sintered body. As a result, the ceramics layer 13a can be formed. Specifically, the base body 11, the electrodes 12a and 12b, and the ceramics compact are fired, while being pressurized in a uniaxial direction, based on firing conditions (e.g., firing atmosphere, firing temperature, firing time) depending on the base body 11 and the ceramics compact.

Although the flow diagram of FIG. 3 illustrates an embodiment where the manufacture of the base body (S101), the manufacture of the electrode (S102), and the manufacture of the dielectric material layer (S103) are performed in this order, the order of these steps (S101) to (S103) is not limited to this order. For example, the ceramics layer 13a may be previously manufactured prior to the formation of the electrodes 12a and 12b on the ceramics layer 13a and then a compact as the base body 11 is formed on the ceramics layer 13a and the electrodes 12a and 12b to subsequently fire them in an integrated manner. By firing any of the base body 11 or the ceramics layer 13a to subsequently form the electrodes 12a and 12b prior to the integrated firing as described above, the electrodes 12a and 12b can have an improved flatness. This can provide the electrostatic chuck with a more uniform wafer adsorption power and an improved thermal uniformity. Alternatively, a layered structure of a ceramics compact as the base body 11, the electrodes 12a and 12b, and a ceramics compact as the ceramics layer 13a may also be manufactured and then the resultant layered structure may be integrally fired by the hot press method or the like.

Next, the resultant sintered body is machined (S104). Specifically, the projections 13e as a base of the projections 13c for supporting the substrate 1 are formed, by a grinding or a blasting, on the top face of the ceramics layer 13a. The ceramics layer 13a is subjected to a grinding or a polishing so as to have a predetermined thickness or the like. The holes 11a are formed in the base body 11 by a drilling so that the holes 11a are inserted with the terminals 14.

Next, the integrated sintered body of the base body 11, the electrodes 12a and 12b, and the ceramics layer 13a is cleaned by organic solvent to remove dirt and oil (S105). Then, the integrated sintered body is fired as it is to remove dirt and oil (S106). The integrated sintered body is fired, for example, in an oxygen atmosphere in a furnace with 400 to 450° C. As a result, the dirt and oil are thermally decomposed and are removed. The cleaning (S105) and firing (S106) as described above degrease the integrated sintered body.

Next, a portion of the ceramics layer 13a where the resin layer 13b is formed is coated with primer liquid as the primer layer 13f (S107). For example, the surface of the ceramics layer 13a can be coated with primer liquid by coating a portion on the surface of the ceramics layer 13a where the resin layer 13b is formed with primer liquid by brushing or spraying or by immersing a portion on the surface of the ceramics layer 13a where the resin layer 13b is formed in the primer liquid.

Then, the coated primer liquid is dried and fired (S108). This improves the contact strength between the primer layer 13f and the ceramics layer 13a. The coating by the primer liquid (S107) and the firing (S108) as described above can form the primer layer 13f on a portion of the ceramics layer 13a where the resin layer 13b is formed.

Next, the primer layer 13f formed on the surface of the ceramics layer 13a is coated with coating liquid including a component as the resin layer 13b (hereinafter referred to as “resin layer component”) (S109). The coating liquid can include, as the resin layer component, fluorocarbon resin, epoxy resin, acrylic resin, or silicone resin for example. For example, the primer layer 13f can be coated with the coating liquid by brushing or spraying, by a screen printing or by immersing the primer layer 13f in the coating liquid.

Then, the coated coating liquid is dried and fired (S110). The firing can be performed based on firing conditions (e.g., firing temperature, firing time) depending on the resin layer component included in the coating liquid. For example, when the resin layer 13b is formed by the coating by coating liquid including fluorocarbon resin as a resin layer component, the firing is preferably performed with 400 to 450° C. for 1 to 10 hours for PTFE or 350 to 400° C. for 1 to 10 hours for PFE. The coating by the coating liquid including the resin layer component (S109) and the firing (S110) as described above can form the resin layer 13b having a film-like shape on the primer layer 13f. As a result, the resin layer 13b can be formed on the ceramics layer 13a having the primer layer 13f interposed therebetween.

Finally, the terminals 14 are inserted to the holes 11a of the base body 11 and the terminals 14 are connected to the electrodes 12a and 12b by brazing, thereby providing the electrostatic chuck 10.

Instead of the steps for forming the resin layer 13b having a film-like shape (S109 and S110), the resin layer 13b may also be formed by adhering the resin layer 13b having a sheet-like shape to the ceramics layer 13a. When an electrostatic chuck not including the primer layer 13f is manufactured, the steps required for the formation of the primer layer 13f (S107 and S108) may be omitted.

Furthermore, when the resin layers 23b and 33b shown in FIG. 2A and FIG. 2B are formed, the resin layer 23b may be formed only at the top faces of the projections 13e on which the resin layer 23b is formed or the resin layer 33b having a projection-like shape may be formed at the top face of the ceramics layer 33a by a screen printing or the like as in the method as shown in FIG. 3. Alternatively, the resin layer 33b having a projection-like shape may also be adhered to the ceramics layer 33a to form the resin layer 33b.

When an electrostatic chuck is manufactured in which a resistance heating element is buried in the base body 11, the resistance heating element may be buried in a ceramics compact as the base body 11 and the compact may be fired. When the base body 11 is a base body made of metal or a composite material of metal and ceramics for example, the steps (S101) to (S103) can integrally adhere the base body 11, the electrodes 12a and 12b, and the ceramics layer 13a by adhesive agent.

The electrostatic chuck 10 and the producing method thereof as described above can use the resin layer 13b on the ceramics layer 13a to suppress excessive leak current from being generated, thus providing the electrostatic chuck 10 having high voltage resistance. When an electrostatic chuck using the Johnson-Rahbek force is used, minute leak current must be flowed in the substrate 1. However, excessive leak current in an amount more than required may have an influence on the substrate 1. The electrostatic chuck 10 can suppress the leak current into the substrate 1 within a required range, thus preventing excessive leak current in an amount more than required from being generated.

Furthermore, the dielectric material layer 13 has a superior corrosion resistance owing to the ceramics layer 13a and the condition of the-surface thereof does not change owing to the resin layer 13b even when the electrostatic chuck is used for a long time. Thus, the adsorption characteristic of the electrostatic chuck 10 can be maintained for a long time and the electrostatic chuck 10 having a long life can be provided.

Furthermore, in the electrostatic chuck 10, polarization is caused in the resin layer 13b, contributing to the generation of an electrostatic adsorption power. Thus, electric charge does not remain in the ceramics layer 13a after the voltage application to the electrodes 12a and 12b is stopped. As a result, the electrostatic chuck 10 using the Johnson-Rahbek force can have an improved detachment smoothness level of the substrate 1 therefrom. In particular, the electrostatic chuck 10 can maintain favorable detachment smoothness level even when a high voltage is applied to the electrodes 12a and 12b in order to obtain a high adsorption power.

More specifically, in spite of the use of the Johnson-Rahbek force, the electrostatic chuck 10 can show an adsorption characteristic and a detachment smoothness level similar to those shown by an electrostatic chuck using the Coulomb force. This is presumably attributed the polarization generated almost only in the resin layer 13b. Due to this, the adsorption power disappears only by allowing the condition of the polarization in the resin layer 13b to return to the original condition after the voltage application, thus providing an improved detachment smoothness level.

The resin layer 13b is formed on the ceramics layer 13a and the substrate 1 has a contact with the resin layer 13b. This can prevent the ceramics layer 13a from scratching the back face of the substrate 1, preventing the generation of particles.

### EXAMPLE

Next, the present invention is described in further detail by an example. However, the present invention is not limited to the following example.

As raw material powders for ceramics, mixed powders of aluminum nitride powders (95 wt %) and yttrium oxide powders (sintering agent) (5 wt %) were prepared. The ceramics raw powders were added with binder and were mixed by a ball mill to provide slurry. The resultant slurry was dried by a spray drier to provide granulated powders. The resultant granulated powders were molded by a metallic molding method into a compact having a plate-like shape. The compact was fired by the hot press method in nitrogen gas atmosphere. Specifically, the compact was fired at 1860° C. for 6 hours while being pressurized.

Next, printing paste was prepared by mixing mixed powders of tungsten (W) (80 wt %) and aluminum nitride powders (20 wt %) with ethylcellulose as a binder. An electrode was formed on the surface of the aluminum nitride sintered body by the screen printing method and was dried.

Next, the aluminum nitride sintered body having thereon the electrode was set in a metallic mold. Then, granulated powders were filled on the aluminum nitride sintered body and the electrode. Then, the aluminum nitride sintered body and the electrode were pressurized and pressed.

Then, the integrated structure of the aluminum nitride sintered body, the electrode, and the aluminum nitride compact was set in a carbon-made case and was fired by the hot press method in nitrogen gas atmosphere. Specifically, this integrated body is fired at 1860° C. for 6 hours while being pressurized.

In this manner, the ceramics layer as a part of a dielectric material layer was obtained. The resultant integrated sintered body of the base body of the aluminum nitride sintered body, the electrode, and the ceramics layer of the aluminum nitride sintered body was processed. Specifically, projections as a base of projections for supporting a substrate were formed by the blasting on the top face of the ceramics layer. The ceramics layer was subjected to a grinding so as to have a predetermined thickness or the like. The base body was subjected to a drilling to have a hole to which a terminal is inserted. The ceramics layer at this point showed a volume resistivity value at room temperature of 2.1×10¹¹ Ω·cm. The top face of the ceramics layer at this point showed an average surface roughness (Ra) at the center line of 1.1 μm.

Next, the integrated sintered body of the base body, the electrode, and the ceramics layer was cleaned by organic solvent to remove dirt and oil. Then, the integrated sintered body was fired as it is by heating at 400° C. for 2 hours in oxygen atmosphere in a furnace, thereby removing dirt and oil.

Next, the primer layer was formed on the top face of the ceramics layer. Then, the primer layer was coated by a brush with coating liquid including polytetrafluoroethylene (PTFE) as fluorocarbon resin and the coating liquid was dried at 23° C. Thereafter, the coating liquid was fired at 400° C. for 5 hours, thereby forming the resin layer. Finally, the terminal was inserted to the hole of the base body and the terminal was connected to the electrode by brazing, thereby providing an electrostatic chuck.

The finally obtained electrostatic chuck had a dielectric material layer that had circular cylinder-shaped projections each having a height of 20 μm and a diameter of 2 mm. The resin layer showed an average thickness of 10 μm and the variation of the thickness of the resin layer was suppressed to be 10 μm or less. After the formation of the resin layer, the dielectric material layer showed a volume resistivity value at room temperature of 2.1×10¹⁴ Ω·cm and the substrate contact face showed an average surface roughness (Ra) at the center line of 0.6 μm.

The adsorption power and the detachment smoothness level of the resultant electrostatic chuck were evaluated in a manner as described below. A silicone-made probe was abutted with the substrate contact face of the electrostatic chuck in vacuum and voltage was applied between the electrode of the electrostatic chuck and the silicone-made probe so that the silicone-made probe was fixedly adsorbed by the electrostatic chuck. Then, the silicone-made probe was pulled up so that the silicone-made probe is peeled from the substrate contact face of the electrostatic chuck. A power required for peeling the silicone-made probe from the substrate contact face of the electrostatic chuck was measured as an adsorption power. Furthermore, a detachment time from a time at which the voltage application was cancelled to a time at which the silicone-made probe was peeled from the electrostatic chuck was measured.

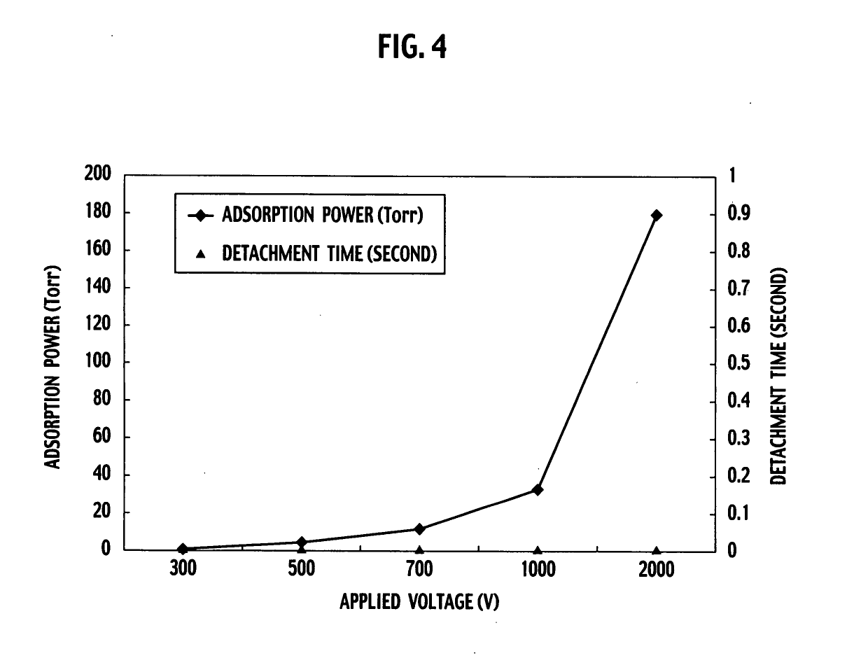

An area of a tip end of the silicone-made probe was 3 cm² and an area at which the silicone-made probe has a contact with the substrate contact face was 4% of the substrate contact face and these areas were measured at room temperature. The voltage applied was changed in an order of 300V, 500V, 700V, 1000V, and 2000V. The evaluation result is shown in FIG. 4. In FIG. 4, the lateral axis represents an applied voltage (V) and the left longitudinal axis represents an adsorption power (Torr) and the right longitudinal axis represents a time required for the detachment (second).

As shown in FIG. 4, in spite of the use of the Johnson-Rahbek force, the electrostatic chuck of the example showed an adsorption characteristic and a detachment smoothness level similar to those of an electrostatic chuck using the Coulomb force. Specifically, the electrostatic chuck showed a high adsorption power with an increase of the applied voltage. Even when the applied voltage was increased, the time required for the detachment was about 0 second, showing a favorable detachment smoothness level.

Furthermore, the leak current at the application of 2000V was 1 μm or less, showing the suppression of excessive leak current. The variation of the thickness of the resin layer was suppressed to be 10 μm or less, thus showing a very small in-plane variation of the adsorption power.

After a wafer was adsorbed by the resultant electrostatic chuck, particles on the surface to which the wafer was adsorbed were measured. In the case of an electrostatic chuck having projections not coated with resin, the total number of particles of 0.15 μm or more was about 30000. In the case of an electrostatic chuck in which only the top faces of the projections are covered by a resin layer, the total number of the particles was about 5000. In the case of an electrostatic chuck in which the entire surface of the electrostatic chuck having projections is covered by a resin layer, the total number of the particles was about 1000. In the case of an electrostatic chuck in which projections are formed by a resin layer on a flat ceramics layer, the total number of the particles was about 8000. Thus, the electrostatic chuck in which the entire surface of the electrostatic chuck having projections is covered by a resin layer showed a remarkable effect for reducing particles.

What is claimed is:

1. An electrostatic chuck using the Johnson-Rahbek force, characterized in comprising:
a dielectric material layer including a ceramics layer and a resin layer formed on the ceramics layer; and
an electrode for generating an electrostatic adsorption power.

2. The electrostatic chuck according to claim 1, characterized in that:
the ceramics layer has a volume resistivity value at room temperature of 1×10⁸ to 1×10¹³ Ω·cm; and
the dielectric material layer has a volume resistivity value at room temperature of 1×10¹⁴ Ω·cm or more.

3. The electrostatic chuck according to claim 1, characterized in that the dielectric material layer has a plurality of projections for supporting a substrate.

4. The electrostatic chuck according to claim 1, characterized in that the resin layer has a thickness of 1 to 30 μm.

5. The electrostatic chuck according to claim 1, characterized in that the resin layer is formed by fluorocarbon resin.

6. The electrostatic chuck according to claim 1, characterized in that the ceramics layer includes aluminum nitride or aluminum oxide.

7. The electrostatic chuck according to claim 1, characterized in that a difference in a thermal expansion coefficient between the ceramics layer and the resin layer is 1×10⁻⁶ to 5×10⁻⁴/K.

8. The electrostatic chuck according to claim 1, characterized in that the ceramics layer and the resin layer have therebetween a primer layer.

9. A producing method of an electrostatic chuck using the Johnson-Rahbek force, characterized in comprising:
a step for forming a dielectric material layer including a ceramics layer and a resin layer formed on the ceramics layer; and
a step for forming an electrode for generating an electrostatic adsorption power.
